(19) United States
(12) Patent Application Publication
(10) Pub. No.: US 2007/0080692 A1
(43) Pub. Date: Apr. 12, 2007

(54) Method and apparatus for performing automated power plant battery backup capacity measurement

(76) Inventor: Glen F. Evans, Fanwood, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/224,172

(22) Filed: Sep. 12, 2005

(51) Int. Cl. G01N 27/416

(52) U.S. Cl. 324/426

(57) ABSTRACT

A method and apparatus for automatically performing a measurement of a power plant's battery backup capacity. The process comprises reducing an output voltage of a rectifier and identifying a time when said output voltage has been so reduced, measuring the voltage (e.g., at the output of the battery) to determine when the battery has been discharged and identifying a time when the battery has been determined to be discharged, calculating the period of time for the battery to discharge based on the two identified times, restoring the output voltage of the rectifier, and comparing the calculated period of time for the battery to discharge to a predetermined minimum acceptable period of time for the battery to discharge. Advantageously, this process is performed automatically at predetermined intervals or in accordance with a predetermined scheduling algorithm, and is advantageously performed during known “off-peak” time periods (e.g., during the overnight hours).

### FIELD OF THE INVENTION

The present invention relates generally to the field of power plants such as those used in telecommunications systems, and more particularly to a method and apparatus for measuring the capacity of a battery backup capability incorporated into such a power plant.

### BACKGROUND OF THE INVENTION

Power plants, such as, for example, those used to power telecommunications systems, typically provide for an automated battery backup capability to protect against the possible loss of the main (typically, AC) power source. Usually, a telecommunications equipment manufacturer who sells such a plant will provide a specific “guarantee” as to the amount of time (e.g., several hours) that protection against power loss will be available from the battery backup system. However, over extended periods of time (e.g., years), it is well known that a battery's available power diminishes. For this reason, battery strings are usually provided which will, in the event of failure of the primary power source, provide somewhat more than the “guaranteed” amount of time (at least initially).

In fact, as is well known to those of ordinary skill in the art, a battery string is considered to have exceeded its useful life when its capacity has diminished to 80% of its original capacity. Thus, if, for example, a telecommunications equipment manufacturer is asked to provide a guarantee of say, 4 hours of battery backup capacity, it will typically provide a backup battery string which has an initial capacity of, in this case, 5 hours. As such, when the battery string's capacity has diminished to below 4 hours (i.e., 80% of its original capacity), it will be deemed to have reached the end of its useful life.

One well known problem in such power plants with battery backup capability is that, in order to ensure the desired battery backup capability, there needs to be some mechanism for deciding when the batteries should be replaced. Conventionally, one of two approaches have been taken to address this problem. In the first approach, an arbitrary period of time (e.g., some predetermined number of years) would be used as a “rule of thumb” worst case scenario (i.e., a period of time over which it was deemed to be very unlikely for the batteries to have reached the end of their useful life), and the batteries would be simply replaced at that time, regardless of their actual condition. In the second approach, trained technicians would travel to the power plant sites and perform a test of the battery backup system, wherein the battery string would be physically disconnected from the power plant, given an artificial load, and allowed to discharge in order to measure the actual capacity (time to discharge) of the battery string. Both of these approaches, however, are quite expensive—the first in terms of unnecessary battery string replacements, and the second in terms of manpower costs.

More recently, a number of alternative “in-place” methods have been proposed. These include, for example, automated methods which measure impedance, voltage, current, and/or temperature, and which have claimed to be able to predict the capacity of the battery based on the measured values of these parameters. However, it has been shown that, in fact, the measured values of these parameters actually have little direct correlation to the capacity of the battery under a true discharge resulting from the failure of the power source.

### SUMMARY OF THE INVENTION

Recognizing that the only accurate way to truly know the capacity of a battery backup system is to run a full discharge on the battery string, the present invention advantageously performs such a discharge with an automated process in which the battery string physically remains in the power plant. Moreover, in accordance with an illustrative embodiment of the present invention, such a process may be advantageously performed without modification to the power plant, other than to software or firmware included within the power plant controller. (Note that the terms “battery string” and “battery” will be henceforth used interchangeably herein, both in the instant disclosure and in the instant claims.)

More particularly, the present invention provides a method and apparatus for automatically performing a measurement of a power plant's battery backup capacity, wherein the method and apparatus comprise the steps of or means for, reducing an output voltage of a rectifier and identifying a time when the output voltage of the rectifier has been reduced, measuring the voltage (e.g., at the output of the battery) to determine when the battery has been discharged and identifying a time at which the battery has been discharged, calculating a period of time for the battery to discharge based on the two identified times, restoring the output voltage of the rectifier, and comparing the calculated period of time for the battery to discharge to a predetermined minimum acceptable period of time for the battery to discharge. Advantageously, this process is performed automatically at predetermined intervals or in accordance with a predetermined scheduling algorithm, and is advantageously performed during known “off-peak” time periods (e.g., during the overnight hours) in order to minimize the risk of a system failure during discharge testing (which would otherwise leave the system vulnerable to providing minimal or no backup assistance).

### BRIEF DESCRIPTION OF THE DRAWINGS

FIG. 1 shows an example of a power plant environment having battery backup capability in which an illustrative embodiment of the present invention may be employed.

FIG. 2 shows a sample flowchart for a method for measuring the capacity of a battery backup capability of a power plant, such as the illustrative power plant of FIG. 1, in accordance with an illustrative embodiment of the present invention.

### DETAILED DESCRIPTION OF THE ILLUSTRATIVE EMBODIMENTS

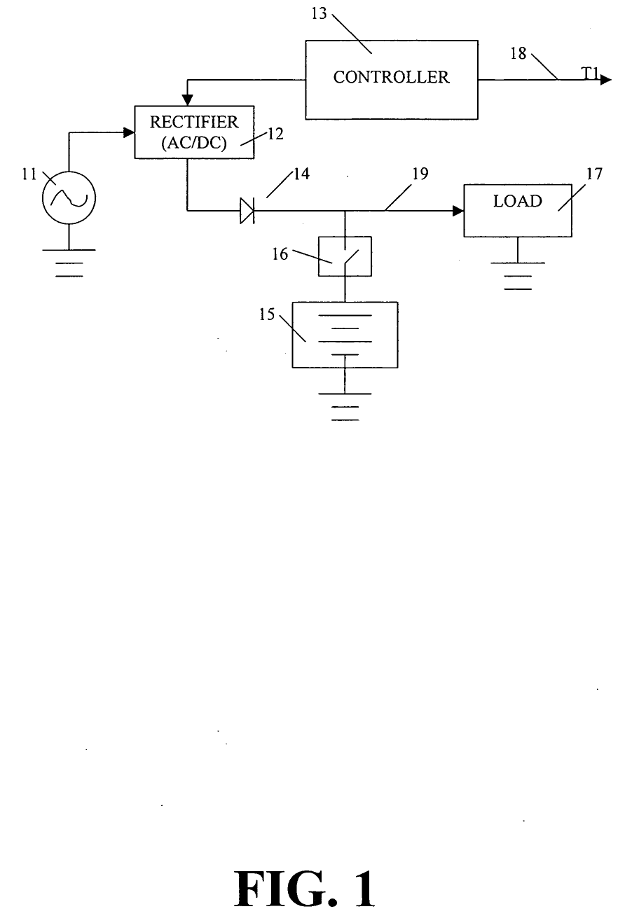

FIG. 1 shows an example of a power plant environment having battery backup capability in which an illustrative embodiment of the present invention may be employed. The illustrative power plant environment comprises AC power source 11, rectifier 12 (which may, in fact, comprise a plurality of rectifiers but will be referenced herein—both in the instant disclosure and in the instant claims—in the singular), controller 13, diode 14, backup battery string 15, low voltage disconnect (LVD) switch 16, load 17 (connected via line 19), and T1 communications line 18. In normal operation of the illustrative power plant of FIG. 1, AC power source 11 provides the primary power source, which may, for example, comprise a conventional 120 volt or 220 volt AC (alternating current) signal, and rectifier 12, under the control of controller 13, provides AC to DC (direct current) conversion capability, thereby producing a DC power source at diode 14. (Note that, in general, such a power plant may actually comprise a plurality of rectifiers to perform the given function of converting a primary AC power source to the DC power source. Thus, as used herein—in both the instant disclosure and in the instant claims—the term “rectifier” is defined to represent one or more rectifiers.) Illustratively, controller 13 advantageously comprises a programmable data processing device capable of monitoring and controlling various aspects of the operation of the power plant. Finally, the DC power source passes through diode 14, thereby providing the required DC power to load 17.

The illustrative power plant of FIG. 1 also includes battery backup capability provided specifically by battery string 15. In operation, whenever the primary power source (i.e., AC power source 11) fails, for example, rectifier 12 will not produce the required DC power, in which case battery string 15 will automatically provide the power (for as long as its capacity allows). Moreover, controller 13 monitors the voltage on line 19 and advantageously disconnects battery string 15 from the circuit when the voltage drops below a minimum threshold, with use of low voltage disconnect switch 16, in order to protect the load from an insufficient voltage and the battery string from being permanently damaged. Finally, note that during normal operation (i.e., when AC power source 11 and rectifier 12 are providing the needed DC power to load 17), battery string 15 is being advantageously recharged on a continuous basis.

Illustratively, the power plant of FIG. 1 may comprise a 48 volt system, wherein load 17 is configured to be provided with an approximately 48 volt power signal. In such a case, rectifier 12 advantageously produces an approximately 54 volt DC output, and battery string 15 comprises a “48 volt” battery string which actually produces approximately 54 volts. Specifically, it is assumed that battery string 15 comprises a VRLA (Valve Regulated Lead Acid) battery string, as is typically used in telecommunications system power plants. (As is well known to those of ordinary skill in the art, 48 volt DC systems are typically provided with an input voltage of approximately 54 volts. Moreover, as is also well known to those of ordinary skill in the art, such systems are typically capable of operating properly on any DC voltage between 42 volts and 54 volts. For the simplicity of the discussion herein, it will be assumed for convenience that 48 volt systems are used in the illustrative embodiments of the present invention.)

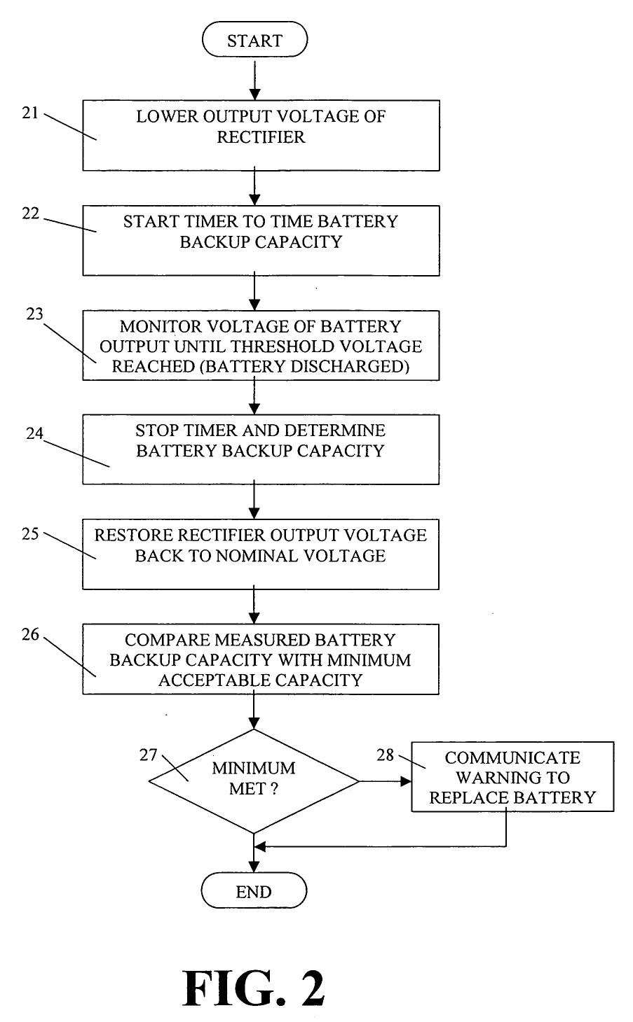

FIG. 2 shows a sample flowchart for a method for measuring the capacity of a battery backup capability of a power plant in accordance with an illustrative embodiment of the present invention. The illustrative procedure of FIG. 2 may be implemented as software or firmware, and may, for example, be executed by controller 13 of the illustrative power plant of FIG. 1.

In accordance with various illustrative embodiments of the present invention, the procedure of FIG. 2 is automatically executed periodically, as determined, for example, by controller 13 of the illustrative power plant of FIG. 1, in order to measure the capacity of the battery backup of the given power plant. For example, it may be automatically executed every 6 or 8 months. Alternatively, it may be executed periodically based on a more sophisticated schedule wherein it is executed relatively less frequently when the battery string is relatively new, and relatively more frequently as the battery string gets older. Numerous such advantageous scheduling algorithms will be obvious to those of ordinary skill in the art. Moreover, most preferably, the procedure of FIG. 2 is advantageously executed during known “off-peak” time periods (e.g., during the overnight hours), regardless of the particular scheduling algorithm employed.

The execution of the illustrative procedure of FIG. 2 begins (as shown in block 21 of the figure) by lowering the output voltage of rectifier 12 of the illustrative power plant of FIG. 1. In accordance with various illustrative embodiments of the present invention, the output voltage of the rectifier may be disconnected or turned off completely (i.e., effectively dropped to 0 volts), or may be advantageously dropped to a voltage just below 42 volts (e.g., 41 volts). Since 42 volts is the “cutoff” (i.e., minimum acceptable voltage for the illustrative 48 volt system), this will require that the battery backup system provide the necessary power to load 17. In accordance with another illustrative embodiment of the present invention, the output voltage of the rectifier may alternatively be advantageously dropped to a voltage barely above 42 volts (e.g., 42.1 volts). This will also require that the battery backup system provide the power required by the load, but will advantageously not subject the load to a voltage below 42 volts after the battery backup capability has been exhausted.

In accordance with the illustrative embodiments of the present invention, once the output voltage of rectifier 12 has been sufficiently lowered to engage the battery backup, a timer is started (as shown in block 22 of FIG. 2), so that the amount of time that the battery backup remains operational may be advantageously measured. Then, as shown in block 23 of FIG. 2, controller 13 continuously monitors the voltage on line 19 until it reaches a level close to the minimum allowed voltage of 42 volts (e.g., until it reaches 42.1 volts). Note that, in accordance with another illustrative embodiment of the present invention, controller 13 simply performs its normal function of monitoring the voltage on line 19 and using low voltage disconnect switch 16 to disconnect the battery when the voltage drops below the minimum threshold of, for example, 42 volts. In either case, as shown in block 24 of FIG. 2, controller 13 stops the timer when the minimum (or close to the minimum) voltage occurs on line 19, and determines the total battery backup capacity based on the amount of time elapsed by the timer.

Next, in accordance with the illustrative embodiments of the present invention, once the timer has been stopped, controller 13 advantageously re-enables rectifier 12 (e.g., restores the rectifier output to its full 54 volt value), as is shown in block 25 of FIG. 2. In this manner, uninterrupted service will be advantageously applied to the system (i.e., load 17), and, moreover, the battery string will be advantageously recharged by the rectifier.

Then, in accordance with the illustrative embodiments of the present invention, the procedure of FIG. 2 (as shown in block 26) compares the measured battery backup capacity with a predetermined amount of time which represents the minimum acceptable battery backup capacity. As described above and as is convention , this amount may, in accordance with the illustrative embodiment of the present invention, be equal to 80% of the original battery backup capacity. However, in accordance with other illustrative embodiments of the invention, this amount may be any other prescribed amount of time. If the comparison between the measured battery backup capacity and the minimum acceptable battery backup capacity indicates that the minimum acceptable battery backup capacity is not met (as shown in decision block 27 of FIG. 2), a warning message is advantageously communicated back to, for example, a central monitoring station, illustratively with use of T1 communications line 18 (as shown in block 28 of FIG. 2), thereby alerting the power plant operator that the backup batteries are in need of replacement.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, although the above described illustrative embodiments have focused on power plants such as those used in telecommunications systems, it will be obvious to those of ordinary skill in the art that the principles of the present invention may be equally applied in the context of any uninterruptible power supply (UPS) which provides a battery backup capability to another power source (such as, for example, conventional AC wall current). As such, the use of the term “power plant” herein is intended to include any power system which converts a primary power source to an output voltage and which includes a battery backup capability in case of failure of the primary power source (such as, for example, a UPS).

In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

I claim:

1. An automated method for performing a measurement of battery backup capacity of a power plant, the power plant comprising a power plant controller for controlling the operation of said power plant, a rectifier for converting a primary power source to an output voltage of said rectifier, the output voltage of said rectifier having a nominal voltage level, and a battery for backup in case of a failure of said primary power source, the method comprising the steps of:
(a) reducing the output voltage of the rectifier to a voltage less than the nominal voltage level thereof, and identifying a time when the output voltage of the rectifier has been so reduced;
(b) measuring a voltage to determine when the battery has been discharged, and identifying a time at which the battery has been determined to be discharged;
(c) calculating a period of time for the battery to discharge based on the identified time when the output voltage of the rectifier has been reduced and on the identified time at which the battery has been determined to be discharged;
(d) restoring the output voltage of the rectifier to the nominal voltage level thereof; and
(e) comparing the calculated period of time for the battery to discharge to a predetermined minimum acceptable period of time for the battery to discharge.

2. The method of claim 1 further comprising the step of communicating to a power plant operator that the battery is in need of replacement when said measured period of time for the battery to discharge is less than said predetermined minimum acceptable period of time for the battery to discharge.

3. The method of claim 1 wherein said steps (a) through (e) are performed repeatedly at a predetermined time interval.

4. The method of claim 1 wherein said steps (a) through (e) are performed repeatedly in accordance with a predetermined scheduling algorithm, wherein the predetermined scheduling algorithm is based on an amount of time since the battery was installed in the power plant.

5. The method of claim 1 wherein said steps (a) through (e) are performed during a predetermined off-peak time period.

6. The method of claim 1 wherein the step of reducing the output voltage of the rectifier comprises reducing the output voltage of the rectifier to zero volts.

7. The method of claim 6 wherein the step of reducing the output voltage of the rectifier to zero volts comprises disabling the primary power source and wherein the step of restoring the output voltage of the rectifier to the nominal voltage level thereof comprises re-enabling the primary power source.

8. The method of claim 1 wherein the step of reducing the output voltage of the rectifier comprises reducing the output voltage of the rectifier to a non-zero voltage less than a predetermined minimum voltage level, the predetermined minimum voltage level based on the nominal voltage level of the output voltage of the rectifier.

9. The method of claim 1 wherein the step of reducing the output voltage of the rectifier comprises reducing the output voltage of the rectifier to a voltage which exceeds a predetermined minimum voltage level by a small predetermined threshold, the predetermined minimum voltage level based on the nominal voltage level of the output voltage of the rectifier.

10. The method of claim 1 wherein said predetermined minimum acceptable period of time for the battery to discharge is equal to 80% of an amount of time equal to a period of time for the battery to discharge when the battery is new.

11. A power plant adapted to automatically perform a measurement of battery backup capacity thereof, the power plant comprising:
a power plant controller for controlling the operation of said power plant;
a rectifier for converting a primary power source to an output voltage of said rectifier, the output voltage of said rectifier having a nominal voltage level; and
a battery for backup in case of a failure of said primary power source,
wherein the controller is adapted to perform the steps of:
(a) reducing the output voltage of the rectifier to a voltage less than the nominal voltage level thereof, and identifying a time when the output voltage of the rectifier has been so reduced;
(b) measuring a voltage to determine when the battery has been discharged, and identifying a time at which the battery has been determined to be discharged;
(c) calculating a period of time for the battery to discharge based on the identified time when the output voltage of the rectifier has been reduced and on the identified time at which the battery has been determined to be discharged;
(d) restoring the output voltage of the rectifier to the nominal voltage level thereof; and
(e) comparing the calculated period of time for the battery to discharge to a predetermined minimum acceptable period of time for the battery to discharge.

12. The power plant of claim 11 wherein the controller, is further adapted to communicate to a power plant operator that the battery is in need of replacement when said measured period of time for the battery to discharge is less than said predetermined minimum acceptable period of time for the battery to discharge.

13. The power plant of claim 11 wherein the controller is further adapted to repeat steps (a) through (e) at a predetermined time interval.

14. The power plant of claim 11 wherein the controller is further adapted to repeat steps (a) through (e) in accordance with a predetermined scheduling algorithm, wherein the predetermined scheduling algorithm is based on an amount of time since the battery was installed in the power plant.

15. The power plant of claim 11 wherein the controller is further adapted to perform steps (a) through (e) during a predetermined off-peak time period.

16. The power plant of claim 11 wherein the controller is adapted to reduce the output voltage of the rectifier to zero volts.

17. The power plant of claim 16 wherein the controller is adapted to reduce the output voltage of the rectifier to zero volts by disabling the primary power source and wherein the controller is adapted to restore the output voltage of the rectifier to the nominal voltage level thereof by re-enabling the primary power source.

18. The power plant of claim 11 wherein the controller is adapted to reduce the output voltage of the rectifier to a non-zero voltage less than a predetermined minimum voltage level, the predetermined minimum voltage level based on the nominal voltage level of the output voltage of the rectifier.

19. The power plant of claim 11 wherein the controller is adapted to reduce the output voltage of the rectifier to a voltage which exceeds a predetermined minimum voltage level by a small predetermined threshold, the predetermined minimum voltage level based on the nominal voltage level of the output voltage of the rectifier.

20. The power plant of claim 11 wherein said predetermined minimum acceptable period of time for the battery to discharge is equal to 80% of an amount of time equal to a period of time for the battery to discharge when the battery is new.
